(19) United States
(12) Patent Application Publication
(10) Pub. No.: US 2006/0157318 A1
(43) Pub. Date: Jul. 20, 2006

(54) Money box

(76) Inventor: Guang Rong Gao, Wenzhou (CN)

Correspondence Address: CHARLES E. BAXLEY, ESQ., 90 JOHN STREET, THIRD FLOOR, NEW YORK, NY, 10038, US

(21) Appl. No.: 11/038,832

(22) Filed: Jan. 18, 2005

(51) Int. Cl. G07F 1/04

(52) U.S. Cl. 194/344

(57) ABSTRACT

The present invention relates to money box, including a money box with counting-up function. Said money box with counting-up function includes a main body with a money slot, wherein a sliding way chute and a money identifier are butted on the back side of the money slot at the inside of the money box for receiving and guiding the dropped coins in a standard falling way, and said money box is equipped with a displaying window, said money box not only identifies coins, but also add them up, and display the result of adding-up, and so on variant functions to make kids interest in it.

### BACKGROUND OF THE INVENTION

1. Field of the Invention

The present invention relates to a money box, and more especially to a money box with counting up and indicating functions for coins storing at inside.

2. Description of Prior Art

For developing good habits from childhood days, such like living industriously and frugally and economically, and managing money matters, the parents often give kid a money box for depositing the pocket coins. According to the conventional money boxes, most of them are a pottery opened a money slot for dropping coin into on the top, and some of them are preset a withdrawal bottom door, therefore it is simple in structure with a single function so that it is hard to keep the kids interesting on it.

### OBJECTS AND SUMMARY OF THE INVENTION

For overcoming the above said shortcomings of the prior art, it is therefore a main object of the present invention to provide a money box with counting up and indicating functions, within it is can identify the coins dropped in from the money slot, and count up and indicate the total amount on it in order to make the user know at any time.

This object is achieved by a technical project provided of the present invention, within the money box includes a money slot; the feather of it is that a sliding way chute and a money identifier are butted on the back side of the money slot at the inside of the money box for receiving and guiding the dropped coins in a standard falling way, and said money box is equipped with a displaying window.

Said money slot can be built upon the top side of the money box, said sliding way chute is integrated with two involution half way-blocks, a flat sliding way composed by two involution half way-blocks is mounted on the top end of the hollow inside vertically, the sliding way chute keeps an angle to the level; said money identifier includes a central processing unit (CPU) consisted of a chip microprocessor as the kernel and other peripheral components, and a coin diameter detecting unit set on the sliding way of the coin.

Said coin detecting unit of the money box includes a raster generator set upon the sliding way of coin and a raster receiver set upon the opposite side on another half way-block, so that the raster generator gives out a raw of raster right crossing the sliding way of coin to get the raster receiver, as a coin is sliding down to block some raster, the raster receiver may receive the blocked raster signal, then transmits the signal to said central processing unit (CPU).

Depending on the CUP located on the inside of the money box and the coin diameter detecting unit built on the sliding way of coin, by detecting the diameter of coin, and according to the corresponding relationship between the diameter and the par value of coin, the CPU can reach a coordinated par value as a conclusion, and add up, and indicate on the displaying window of the display unit to show up evidently. In addition, because the CPU is the kernel of said chip microprocessor, so other functions can be developed, such like playing music and giving out light for reminding as dropping coin, and so on.

### BRIEF DESCRIPTION OF THE DRAWINGS

FIG. 1 is a scheme showing the exterior of the present invention.

FIG. 2 is a part sectional side view of the present invention.

FIG. 3 is a cross-section view showing A-A section in FIG. 2.

FIG. 4 is a cross-section view showing B-B section in FIG. 2.

FIG. 5 is a schematic circuit of the present invention.

### DETAILED DESCRIPTION OF PREFERRED EMBODIMENTS

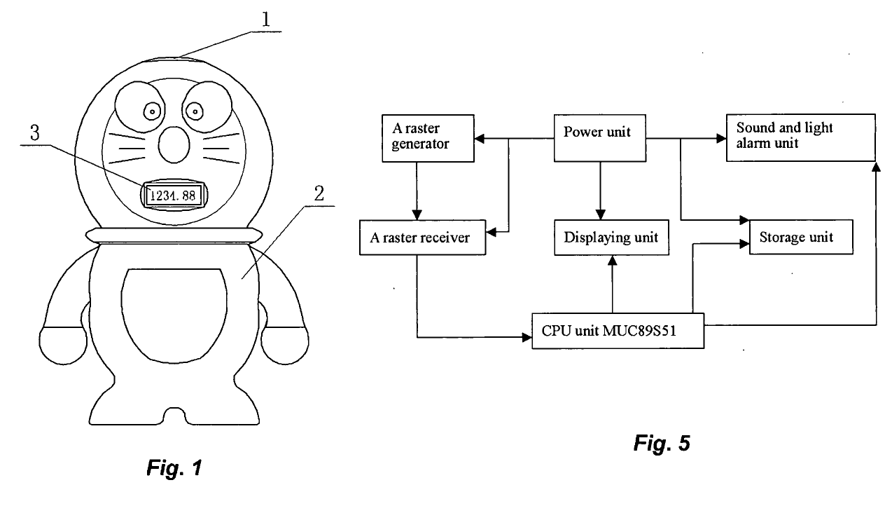

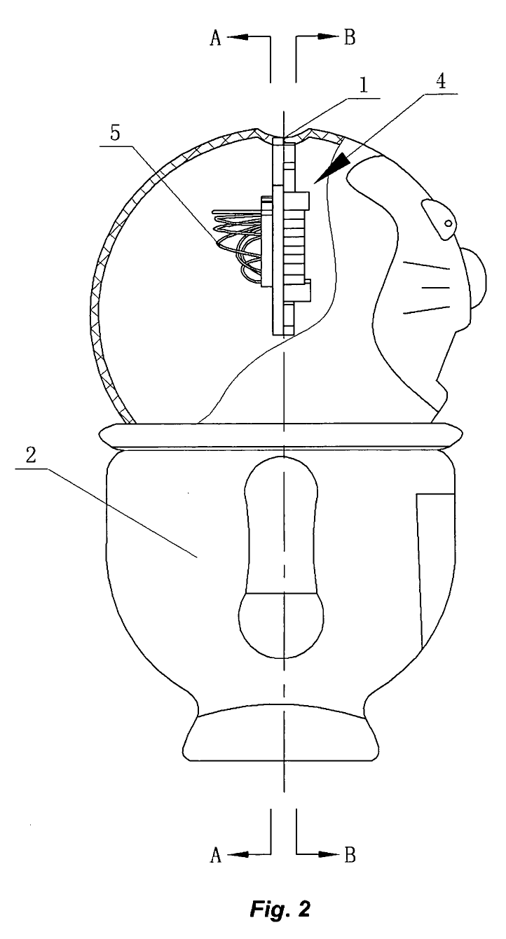

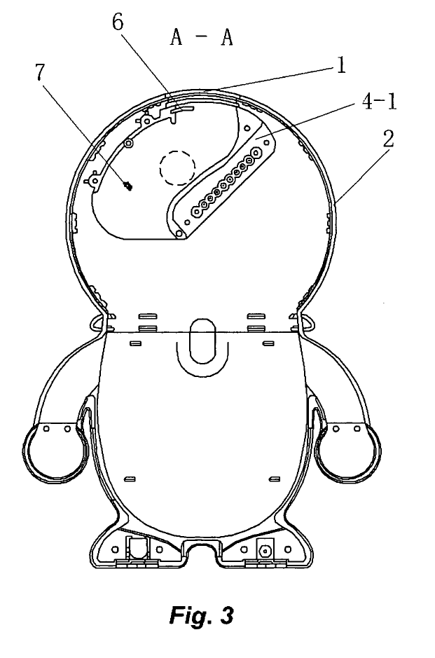

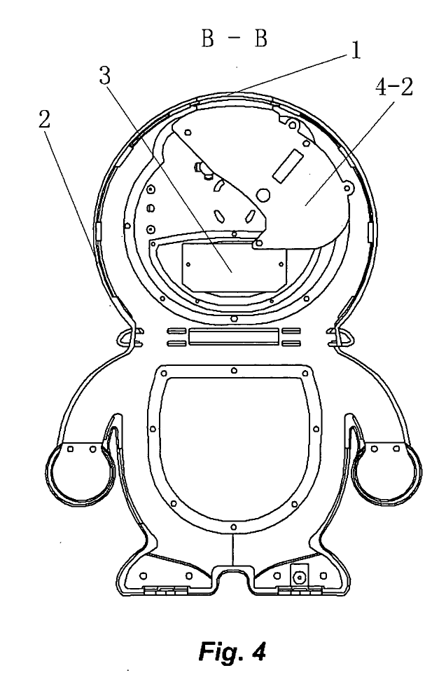

Referring to FIG. 1 and FIG. 2, the money box of the embodiment of the present invention is molded into a cartoon mechanical cat in exterior, the main body 2 is composed of front and back involution half shells molded by injecting plastic in butt-joint; the money slot 1 is built upon the top center, the split coin sliding way chute 4 is jogged by two involution half way-blocks 4-1 4-2, which may be molded by injecting plastic also, within one way-block 4-1 is formed with a S-shaped flat recess in which the depth is a bit more than coin's, and there are several installation holes built upon one side of the sliding way for embedding optical fiber coupler, and another way-block 4-2 is as similar as the first one in shape for butting with it exactly to compose into a sliding way chute 4 with the first one, the split sliding way chute 4 is butted to the inside of the money slot at the hollow inside of head portion of the cartoon vertically, within the sliding way chute 4 is kept an angle with the level (as shown in FIG. 3 and FIG. 4), the angle should not be so big that the coin rolls down too fast that the coin identifier can detect the coin accurately, so the angle should not be bigger than 60°, for controlling the rolling down speed of the coin in a certain range, a damping fin 6 is set upon the intake of the sliding way chute 4 with one end to lap a portion of the money slot 1 with the free end, said damping fin is made of rubber strip, or other soft material with elastic and high friction coefficient replace of; said coin identifier of said money box, as shown in drawings, includes a selected MCU89S52 CPU as the kernel, and selected infrared LED (light emitting diode) as the light source of the taster generator, the raster is set upon the middle of the sliding way opposite arraying several rows of the optical fiber holes right crossing the sliding way, the number of the optical fiber holes is depend on the change range of coin's diameter and the requirement of the accurate. In this embodiment eight 0.75 mm optical fiber holes are set upon, and arranged in two columns right crossing the sliding way chute 4 in adjacent staggered arrangement so that the raster beam is arranged in two columns right crossing the sliding way chute 4 for improving the detecting accurate under the same environment condition; said infrared LED give out infrared light beams led by eight optical fibers 5 to shoot on the sliding way to form raster, coordinating to that, on the opposite side of the sliding way eight optical fibers located on the optical fiber holes separately lead the raster to eight raster receivers consisted of infrared photocells and photo-triodes to receive the blocking signal, then to transmit to input terminal of the MCU89S51 CPU. All the electric circuits are mounted on the hollow inside of the head portion of the cartoon, and the hollow inside of the body of the cartoon is used for storing the coins, for looking at a transparent window is built upon the belly of the body, said displaying screen 3 of the display unit is set upon the mouth portion of the cartoon to increase child interesting on the exterior.

I claim:

1. A money box with counting-up function including a main body with a money slot, wherein said main body is attached with a coin identifier at the hollow inside.

2. A money box with counting-up functions as claimed in claim 1, wherein said coin identifier includes a chip microprocessor as the kernel and other peripheral components, and a coin's diameter detecting unit set on the sliding way of the coin.

3. A money box with counting-up functions as claimed in claim 2, wherein said coin's diameter detecting unit includes a raster generator and a raster receiver set upon the sliding way chute receiving the dropped coin, within said raster generator creates a set of shooting beams crossing the sliding way rightly, said raster receiver located on the opposite side can receive the blocking signal of the raster beams, then transmit to the CPU.

4. A money box with counting-up function as claimed in claim 3, wherein a sliding way chute is butted on the back side of the money slot at the hollow inside of said main body for receiving and guiding the dropped coins in a standard falling way.

5. A money box with counting-up function as claimed in claim 4, wherein the money slot can be built upon the top side of said main body, said sliding way chute is jogged by two involution half way-blocks, a flat sliding way composed by two involution half way-blocks is mounted on the top end of the hollow inside vertically, the sliding way chute keeps an angle to the level; said money identifier includes a central processing unit (CPU) consisted of a chip microprocessor as the kernel and other peripheral components, and a coin's diameter detecting unit set on the sliding way of the coin.

6. A money box with counting-up function as claimed in claim 5, wherein said coin's diameter detecting unit includes a raster generator mounted on a way-block and a raster receiver on another way-block, within said raster generator creates a set of raster shooting crossing the sliding way rightly, and said raster receiver can receive the raster blocking signal, and transmit the blocking signal to the CPU.

7. A money box with counting-up function as claimed in claim 6, wherein said light beams composing of the raster are arranged into two columns right crossing the coin's rolling way, they are in adjacent staggered arrangement.

8. A money box with counting-up function as claimed in claim 6, wherein optical fibers lead the light beam from the light source to the way-blocks.

9. A money box with counting-up function as claimed in claim 7, wherein optical fibers lead the light beam from the light source to the way-blocks.

10. A money box with counting-up function as claimed in claim 1, wherein a damping fin is set upon the intake of the sliding way chute with one end to lap a portion of the money slot with the free end, said damping fin is made of rubber strip, or other soft material with elastic and high friction coefficient replace of; a transparent window is built upon the belly of the body.

11. A money box with counting-up function as claimed in claim 2, wherein a damping fin is set upon the intake of the sliding way chute with one end to lap a portion of the money slot with the free end, said damping fin is made of rubber strip, or other soft material with elastic and high friction coefficient replace of; a transparent window is built upon the belly of the body.

12. A money box with counting-up function as claimed in claim 3, wherein a damping fin is set upon the intake of the sliding way chute with one end to lap a portion of the money slot with the free end, said damping fin is made of rubber strip, or other soft material with elastic and high friction coefficient replace of; a transparent window is built upon the belly of the body.

13. A money box with counting-up function as claimed in claim 4, wherein a damping fin is set upon the intake of the sliding way chute with one end to lap a portion of the money slot with the free end, said damping fin is made of rubber strip, or other soft material with elastic and high friction coefficient replace of; a transparent window is built upon the belly of the body.

14. A money box with counting-up function as claimed in claim 5, wherein a damping fin is set upon the intake of the sliding way chute with one end to lap a portion of the money slot with the free end, said damping fin is made of rubber strip, or other soft material with elastic and high friction coefficient replace of; a transparent window is built upon the belly of the body.

15. A money box with counting-up function as claimed in claim 6, wherein a damping fin is set upon the intake of the sliding way chute with one end to lap a portion of the money slot with the free end, said damping fin is made of rubber strip, or other soft material with elastic and high friction coefficient replace of; a transparent window is built upon the belly of the body.

16. A money box with counting-up function as claimed in claim 7, wherein a damping fin is set upon the intake of the sliding way chute with one end to lap a portion of the money slot with the free end, said damping fin is made of rubber strip, or other soft material with elastic and high friction coefficient replace of; a transparent window is built upon the belly of the body.

17. A money box with counting-up function as claimed in claim 8, wherein a damping fin is set upon the intake of the sliding way chute with one end to lap a portion of the money slot with the free end, said damping fin is made of rubber strip, or other soft material with elastic and high friction coefficient replace of; a transparent window is built upon the belly of the body.

18. A money box with counting-up function as claimed in claim 9, wherein a damping fin is set upon the intake of the sliding way chute with one end to lap a portion of the money slot with the free end, said damping fin is made of rubber strip, or other soft material with elastic and high friction coefficient replace of; a transparent window is built upon the belly of the body.
